(19) United States
(12) Patent Application Publication
(10) Pub. No.: US 2010/0303135 A1
(43) Pub. Date: Dec. 2, 2010

(54) METHOD AND APPARATUS FOR DIRECT RF TO DIGITAL CONVERTER

(76) Inventors: Paul Cheng-Po Liang, Santa Clara, CA (US); Koji Takinami, Saratoga, CA (US)

Correspondence Address: SNELL & WILMER L.L.P. (Panasonic), 600 ANTON BOULEVARD, SUITE 1400, COSTA MESA, CA, 92626, US

(21) Appl. No.: 12/474,178

(22) Filed: May 28, 2009

(51) Int. Cl. H04B 1/38; H04L 27/00; H04L 27/06

(52) U.S. Cl. 375/219; 375/295; 375/340

(57) ABSTRACT

The invention relates to a method and apparatus for decomposing a high frequency incoming signal into several low frequency signals without the loss of any information. The low frequency signals can define a plurality of digital data streams. The decomposing steps are implemented without processing the signal through a mixer or a local oscillator and without degrading the SNR. In a preferred embodiment, a decomposing circuit includes a single-to-differential converter for decomposing the incoming high frequency signal into a first and a second signal having opposite polarity. Each of the first and the second incoming signals is then processed through multistage cascading logic units which reduce the frequency of the respective signals to provide a plurality of low-frequency data streams. The resulting slow-speed data streams are combined to form a low-speed data stream containing all the information provided by the original high-frequency signal.

### BACKGROUND

1. Field of the Invention

The present invention provides an efficient mean for directly measuring frequency of an RF signal using low speed digital circuits and without the need to down-convert the (radio frequency) RF signal. More specifically, the present invention relates to a method and apparatus for decomposing an RF signal into a plurality of low frequency data streams without the use of extraneous circuit components such as local oscillators, mixers or offset phase-locked loops.

2. Description of Related Art

All RF communication systems require converting an incoming RF signal into a digital representation of the signal for further processing. The signal processor must also detect the frequency and the phase of the incoming signal and produce another signal that has a fixed relationship to the phase and frequency of the incoming signal. In conventional signal processing, a mixer and an offset phase-locked loop (“PLL”) are frequently used to down-convert the RF signal into a low frequency, or baseband, signal which is suitable for signal processing. A conventional down-converting process requires multiple processing elements which can consume an ever increasing portion of the circuit's footprint and can be otherwise inefficient.

As the size of electronic radio devices decreases, the need for smaller integrated chip (“IC”) processors increases. High integration and low power consumption are usually key to the success of future mobile communication ICs. Consequently, digital implementation is favored over conventional analog implementation as the latter provides smaller footprint, lower power consumption and a higher signal-to-noise ratio.

Conventional approaches to down-converting a high frequency signal fall into two categories. The first type of implementation uses a mixer and a local oscillator (“LO”) to convert the high frequency signal to a low frequency signal. This implementation is shown in FIG. 1, where high frequency input signal S is directed to phase detector 110. Phase detector 110 detects an initial signal phase and directs the signal S to low pass filter (“LPF”) 120. The filtered signal is then directed to voltage-controlled oscillator (“VCO”) 130. The voltage input to VCO 130 is not shown. The output of VCO 130 and local oscillator (“LO”) 140 are directed to mixer 150. Mixer 150 convolves the two signals to digital converter (FDC) 160 which converts the convolved signal into a digital word. The digital word can represent the frequency information of the down-converted signal. The frequency information is used by phase detector 110 to iteratively determine the phase of signal S. A drawback of the circuit of FIG. 1 is the need for a mixer 150 and a local oscillator 140 which cumulatively increase the circuit's footprint and render the process inefficient.

A second type of conventional down-converters implements a so-called “divide-by-N” algorithm. FIG. 2 schematically illustrates one such down-converting circuit. In FIG. 2, a frequency input signal S is directed to phase detector 210. The signal is then directed to LPF 220. The resultant filtered signal is directed to VCO 230. The oscillating signal is then fed to the divide-by-N logic circuit, where the high frequency signal is reduced to a low frequency signal by implementing the divide-by-N algorithm. However, the circuitry and algorithm may degrade the signal-to-noise ratio (“SNR”) by about 10 log₁₀ N. The degraded SNR can adversely affect signal processing and speed.

Therefore, there is a need for an improved method and apparatus for decomposing a high-frequency signal to one or more low-frequency digital data streams without requiring extraneous circuit elements or degrading the SNR.

### SUMMARY

The present invention is directed to a method and apparatus for decomposing a high frequency signal into a plurality of digital data streams. Frequency decomposing can be implemented without processing the signal through a mixer or a local oscillator and without degrading the signal-to-noise ratio. In other words, the incoming signal is directly decomposed without the need to process the signal through a mixer or a local oscillator. The decomposition disclosed herein does not degrade the signal-to-noise ratio

In one embodiment, the decomposing circuit includes a single-to-differential circuit for decomposing the incoming high frequency signal into a first and a second signal having opposite polarities. Each of the first and the second incoming signals is then processed through a multistage cascading logic circuit which reduces the frequency of the respective signals to provide a plurality of low-frequency digital data streams. The resulting slow-speed data streams are then combined to form a low-speed data signal containing all the information provided by the original high-frequency signal. Some of the advantages of the decomposing circuit are that: (i) signal information is obtained without any loss of information; (ii) the circuit footprint is reduced because LO and mixer are removed; and (iii) the SNR is not degraded.

In another embodiment, the disclosure relates to a method for decomposing a high frequency signal to a plurality of low-frequency data streams by: (i) receiving a high-frequency incoming RF signal; (ii) decomposing the incoming signal into a first signal and a second signal; (iii) processing the first signal at a first logic unit to provide a first output signal, the first output signal preserving a rising edge of the first differential signal; and (iv) processing the second signal at a second logic unit to provide a second output signal, the second output signal preserving a falling edge of the first differential signal, the second output signal being synchronous with the first output signal. This method results in each of the first output signal and the second output signal having about half of the frequency of the incoming signal while still containing all the information contained in the incoming signal.

In another embodiment, the disclosure relates to an apparatus for decomposing a high frequency incoming signal to a plurality of low-frequency data streams. The apparatus includes: a single-to-differential unit for decomposing the incoming signal into a first signal and a second signal; and a first logic unit for processing the first differential signal into a first output signal. The first output signal preserves a rising edge of the first signal. The apparatus also includes a second logic unit for processing the second signal into a second output signal. The second output signal preserves a rising edge of the second signal. The second output signal is substantially synchronous with the first output signal and each of the first output signal and the second output signal has a frequency of about half of the incoming signal while containing all the information contained in the incoming signal.

In still another embodiment, the disclosure relates to a frequency decomposition system having: a decomposition circuit for decomposing a pair of high frequency differential signals to a plurality of low speed data streams; a filter circuit for synchronizing the plurality of low speed data streams with the pair of high frequency differential signals to form synchronized low speed data streams; a clock circuit for re-clocking the low speed data streams; and a logic circuit for extracting data from the reclocked low speed data streams; wherein the decomposition circuit includes a plurality of cascading circuit elements arranged in a multitier cascade to decompose the pair of high frequency differential signals into a number of low speed data streams corresponding to a number of circuit elements in the last stage of the multitier cascade.

In still another embodiment, the disclosure relates to an RF receiver system. The RF system comprises: a modulation circuit modulating a digital signal with a digital carrier frequency to form a modulated digital signal; a frequency synthesizer receiving the modulated digital signal and providing an output signal; a phase frequency detector for comparing the output signal of the frequency synthesizer with a measured frequency of a reference phase and producing an error phase signal; a voltage-controlled oscillator receiving the error phase signal and providing a modulation output frequency signal; and a direct RF-to-digital converter (“DrfDC”) receiving the modulation output frequency signal and providing a processed frequency signal to the detector. The DrfDC includes a multistage cascade of circuit elements for decomposing a high frequency signal to a digital word.

In another embodiment, the disclosure relates to a handheld transceiver for directly measuring frequency without down-converting an RF signal, the transceiver comprising: an antenna receiving the RF signal; a low-noise amplifier amplifying the received signal to an amplified RF signal; a circuit for decomposing the amplified RF signal into at least one slow speed data stream containing all level change information of the RF signal; a decision logic unit receiving the at least one slow speed data stream and obtaining level change information therefrom; and a baseband processor for processing the level change information; wherein the slow speed data stream contains the level change information from all rising edges and all falling edges of the RF signal.

In a further embodiment, the disclosure relates to a method for directly decomposing a high frequency RF signal to a plurality of slow-speed signals, the method comprising: receiving the RF signal at an antenna; amplifying the received signal to an amplified signal; decomposing the amplified signal into at least one slow speed data stream, the slow speed data stream containing all level change information of the RF signal; extracting the level change information from the slow speed data stream; and processing the extracted information at a baseband processor; wherein the slow speed digital data stream contains the level change information from all rising edges and falling edges of the RF signal.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 shows a conventional down-converting circuit which requires a mixer and a local oscillator;

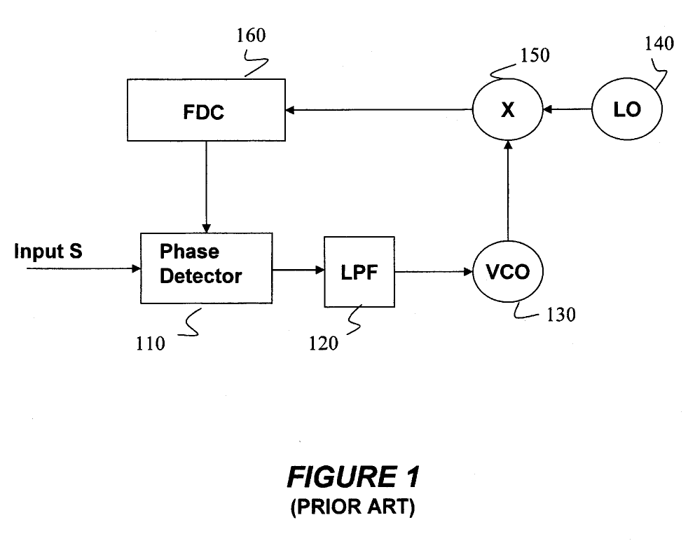

FIG. 2 shows a conventional down-converting circuit implementing the divide-by-N algorithm;

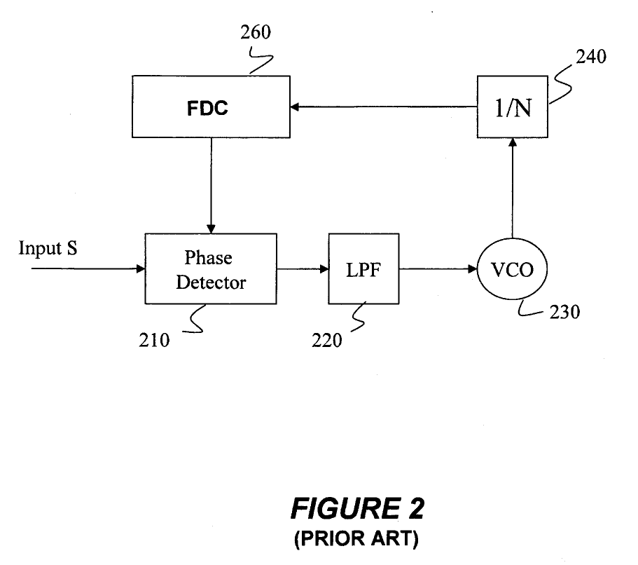

FIG. 3 is a decomposing circuit according to one embodiment of the disclosure;

FIG. 4 demonstrates pulse trains processed by the circuit of FIG. 3;

FIG. 5 is a multistage cascading circuit for decomposing a high frequency signal into a plurality of slow-speed digital data streams;

FIG. 6 illustrates the frequency response of each stage of the circuit shown in FIG. 5;

FIG. 7 illustrates a signal processing circuit with a reclocking circuit according to one embodiment of the disclosure;

FIG. 8 illustrates a multistage circuit for extracting level change data from an input signal according to another embodiment of the disclosure;

FIG. 9 demonstrates pulse trains processed by the circuit of FIG. 8;

FIG. 10A is a schematic representation of a transmitter using the DrfDC of the present invention;

FIG. 10B is a schematic illustration of a frequency synthesizer using a DrfDC according to another embodiment of the disclosure;

FIG. 11 shows the test results for a two-stage DrfDC apparatus;

FIG. 12 is a schematic representation of a three stage cascading DrfDC according to another embodiment of the disclosure;

FIG. 13 shows the test results for a three-stage DrfDC apparatus operating at GSM850 band;

FIG. 14 shows the test results for a three-stage DrfDC apparatus operating at GSM1900 band;

FIG. 15 is a schematic representation of a receiver using the DrfDC of the present invention; and

FIG. 16 is a method for implementing an embodiment of the invention in a transceiver.

### DETAILED DESCRIPTION

The present invention provides a direct RF-to-digital converter (“DrfDC”) which enables directly decomposing a high frequency signal into a plurality of digital data streams for signal processing. The present invention does not require a local oscillator, a mixer or an offset PLL which have been used in conventional systems to obtain the same results. The front-end of the disclosed DrfDC decomposes the high frequency RF signal into several low frequency signals without loss of any information. The low frequency signals are processed by the back-end of the DrfDC and are converted into digital data streams. These digital data streams are then combined into one signal to represent the frequency of the input RF signal.

The digital data streams (even when combined into one signal) retain all of the level change information carried by the high frequency signal. The present invention operates with no information loss. Whereas the conventional system only captures the rising edge of the incoming signal, the present invention operates by capturing both the rising and the falling edges of the signal. Therefore, no information is lost.

The disclosed embodiments are particularly suitable for use in all transceivers and portable electronics, including: mobile telephones, geopositioning systems (“GPS”) and stationary or mobile transceivers.

The present invention is particularly advantageous over the conventional systems because it does not require extraneous circuit elements such as local oscillators or mixers. Consequently, the required circuit footprint is substantially smaller than the conventional systems and the circuit can be formed into an IC suitable for portable and/or handheld devices.

Because the present invention does not require a local oscillator, a mixer or an offset PLL, it draws significantly less power than the existing systems. Consequently, if used in a portable device, the battery will last longer or can be reduced in size to accommodate a smaller design.

Another important advantage of the present invention over conventional systems is its ability to provide superior signal quality. While the conventional systems reduce SNR, the disclosed embodiments extract signal information without affecting the SNR. As a result, the invention is particularly suitable for use in devices requiring high signal fidelity such as mobile telephones.

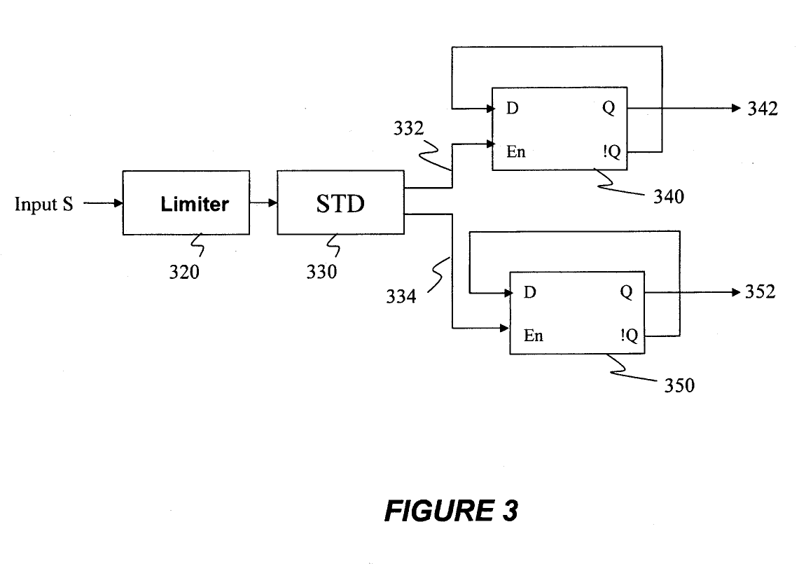

FIG. 3 is a decomposing circuit according to one embodiment of the disclosure. Referring to FIG. 3, input signal S can define a high-frequency input signal which is received at the frontend of an RF receiver. Limiter 320 can be used for receiving input signal S and providing an output signal to single-to-differential (“STD”) 330. STD 330 can be any conventional circuit for generating two balanced output signals from one single-ended input signal. STD 330 decomposes the incoming signal into first signal 332 and second signal 334. First signal 332 and second signal 334 can be substantially synchronous signals with opposite phases.

The first and the second signals are then processed through a plurality of logic units. In one embodiment, the logic units are defined by clocked or edge-triggered devices (i.e., devices having conceptual combination of a transparent-high latch with a transparent-low latch.) In a preferred embodiment, the logic unit defines a pulse-triggered, edge-triggered flip-flop or a shift register.

Referring to the illustrative embodiment of FIG. 3, flip-flops 340 and 350 receive first signal 332 and second signal 334, respectively. First output signal 342 and second output 352 define digital data streams with half of the frequency of input signal S. When combined, first output signal 342 and second output signal 352 form a combined signal with about half of the speed of input signal S while containing all the information carried by input signal S.

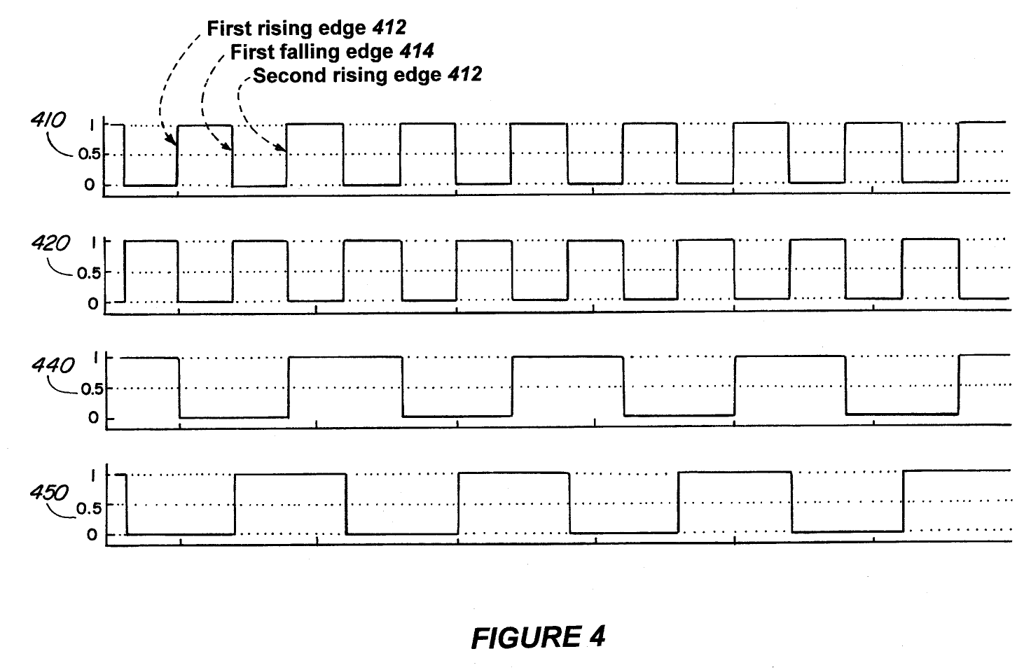

FIG. 4 demonstrates pulse trains processed by the circuit of FIG. 3. In FIG. 4, signal pulse train 410 depicts first signal 332 of STD 330. Signal pulse train 420 depicts second signal 334 of STD 330. The first and second signals have substantially the same frequency as incoming signal S (FIG. 3). It is evident from FIG. 4 that signal pulse trains 410 and 420 are substantially inverse of one another and that they are substantially synchronous with each other. First rising edge 412 of signal 410 is preserved in pulse train 440 which is output signal 342 (FIG. 3). Similarly, first falling edge 414 is preserved in pulse train 450 which is output signal 352 (FIG. 3).

Signal pulse train 440 preserves every other level change of first signal 410 (or second signal 334). Similarly, signal pulse train 450 preserves every other level change in first differential signal 410 (or second signal 334). Consequently, signal pulse trains 440 and 450 have a frequency of about half of that of first signal 332 or second signal 334 while capturing all of the transition information conveyed by the original signals. Thus, the circuit of FIG. 3 decomposes a high frequency signal into two slower digital streams while preserving all the transition information of the input signal S.

In another embodiment of the invention, a circuit may be devised to preserve every other rising edge or falling edge of the differential signal. In still another embodiment, one out of every several rising edges can be preserved to further slow the speed of the incoming signal.

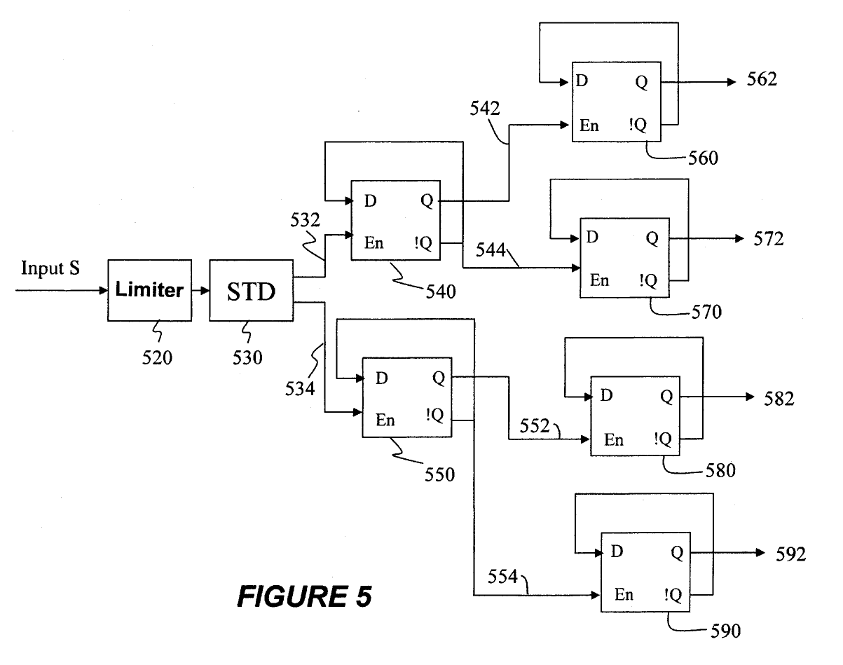

FIG. 5 is a multistage cascading circuit for decomposing a high frequency signal into a plurality of slow-speed digital data streams. In FIG. 5, input signal S is provided as input RF signal to limiter 520, and subsequently, to STD 530. STD 530 directs first signal 532 and second signal 534 to first logic unit 540 and second logic unit 550, respectively. First output signal 542 is directed to third logic unit 560 and second output signal 544 is directed to fourth logic unit 570. As evident in FIG. 5, the multistage cascading circuit decomposes the signal without requiring a mixer or a local oscillator.

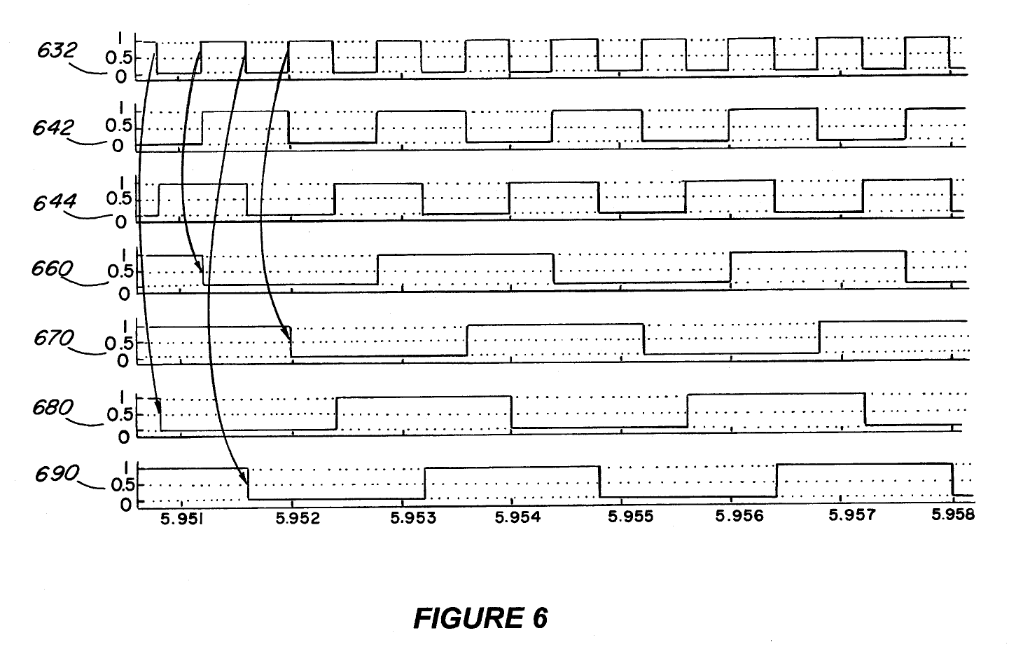

First logic unit 540 and second logic unit 550 define the first stage of the multistage cascading circuit. As will be demonstrated with reference to FIG. 6, the first stage can provide digital data streams having about half of the speed of the original signal. The digital data streams contain all of the transition information of input signal S.

Logic units 560, 570, 580 and 590 define the second stage of the cascading circuit. Logic units 560, 570, 580 and 590 receive digital data streams 542, 544, 552 and 554, respectively, from the first stage and further reduce the speed and frequency of the received data streams. Outputs 562, 572, 582 and 592 define digital data streams which cumulatively contain all original data contained in input signal S. Each of outputs 562, 572, 582 and 592 has a signal speed of about one-fourth of the input signal S.

FIG. 6 illustrates the frequency response at each stage of the cascading circuit of FIG. 5. Referring to FIGS. 5 and 6 simultaneously, pulse train 632 depicts first signal 532 from STD 530 of FIG. 5. Pulse trains 642 and 644 depict signal outputs 542 and 552, respectively. In other words, pulse train 642 is the output of first logic unit 540. As evident from FIG. 6, pulse train 642 preserves the rising edge of pulse train 632. That is, every time there is a rise in pulse train 632, signal 642 switches from one state to another. Similarly, pulse train 644 preserves the falling edge of pulse train 632 and every time there is a fall in pulse train 632, signal 644 switches from one state to another. Signal pulse trains 642 and 644 are at about half of the frequency of signal 632 or, put differently, signal output from first logic unit 540 is at half speed of the input signal S.

Signal trains 660, 670, 680 and 690 are the outputs of logic units 560, 570, 580 and 590, respectively. Pulse train 660 preserves the rising edge of signal 642 while pulse train 670 preserves the falling edge of signal 642. Similarly, pulse train 680 preserves the rising edge of signal 644 while pulse train 690 preserves the falling edge of signal 644. It is evident from FIG. 6 that output signals from the second stage logic units are about half of the frequency of that of the first stage's output signal or about one-fourth of the frequency of its input signal.

In FIG. 5, the first stage of the multistage circuit includes two logic elements while the second stage includes four logic elements. If x defines the number of logic elements at each stage, the relationship between the signal input signal's frequency (Fᵢₙ) and output frequency at each stage (Fₒᵤₜ) can be summarized as:

Fₒᵤₜ=(1/x)Fᵢₙ (1)

That is, the output frequency of each stage will be inversely proportional to the input frequency of each stage. The frequency relationship is also a function of the number of logic elements at each stage. Accordingly, the frequency of output signal 544 is about half (x=2, for the first stage) of the input frequency of signal S (see FIG. 5). Similarly, the frequency of output signal 562 is about one-fourth (x=4, for the second stage) of the input frequency of signal S.

In one embodiment of the disclosure, a multi-stage device can be constructed to have n stages, in which the number of logic units is determined by the relationship:

$$Total Number of logic units = {\sum }_{i = 1}^{n} {2}^{i} . \qquad ( 2 )$$

Thus, an exemplary device having 3 stages (n=3) would have 14 logic units and a device having five (n=5) stages would have 62 logic devices. The logic devices can be laid out in the cascade-type architecture disclosed herein.

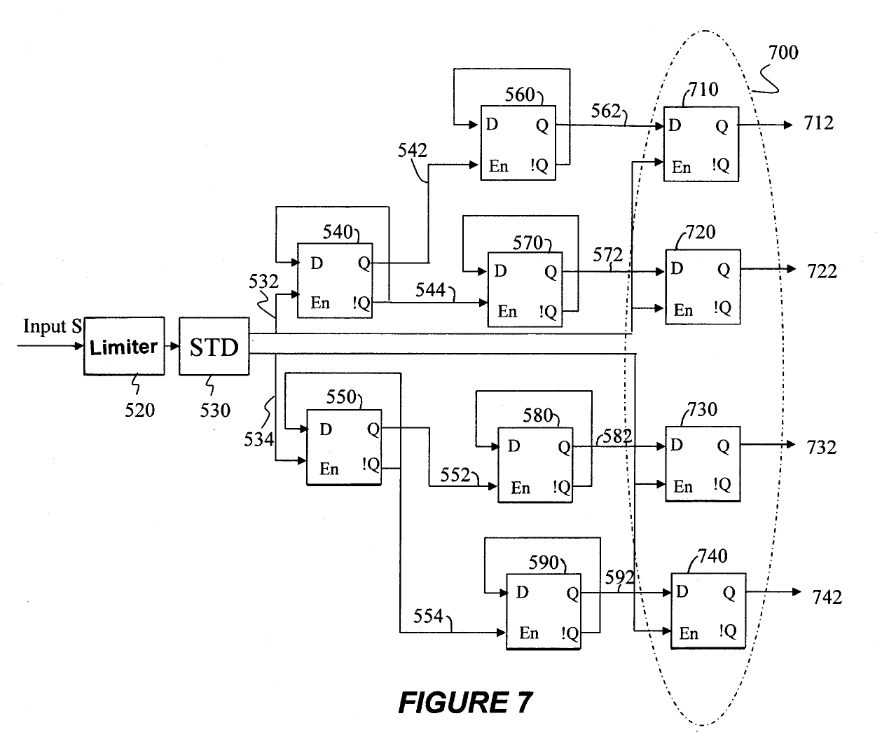

FIG. 7 illustrates a signal processing circuit with a reclocking circuit according to one embodiment of the disclosure. Specifically, FIG. 7 shows the multistage cascade circuit of FIG. 5 (using the same reference numbers) and reclocking circuit 700. Reclocking circuit 700 includes logic elements 710, 720, 730 and 740. In the embodiment of FIG. 7, flip-flops are used as logic elements. Logic elements 710, 720, 730 and 740 receive input signals 562, 572, 582 and 592, respectively, and reclock the inputs with one of first or second differential signals 532 or 534. Reclocking the slow speed data streams 562, 572, 582 and 592 with their corresponding original signals 532 and 534 eliminates accumulated clock jitter from the multistage cascading circuit.

Clock jitter is the time variation of a characteristic of a periodic signal in electronics and telecommunications. Clock jitter does not usually change the physical content of the information being transmitted. Instead, the time at which the information is delivered is disturbed. Clock jitter can be observed in the frequency of successive pulses, the signal amplitude, or phase of periodic signals. Clock jitter can be significant and is an undesired factor in the design of communications links.

Output signals 712, 722, 732 and 742 of FIG. 7 define low speed digital data streams. The low speed digital streams contain the data carried by the input signal S. As such, digital data streams 712, 722, 732 and 742 can be clocked to reference signal and processed through various logic circuits to extract the level change information from the low speed data streams.

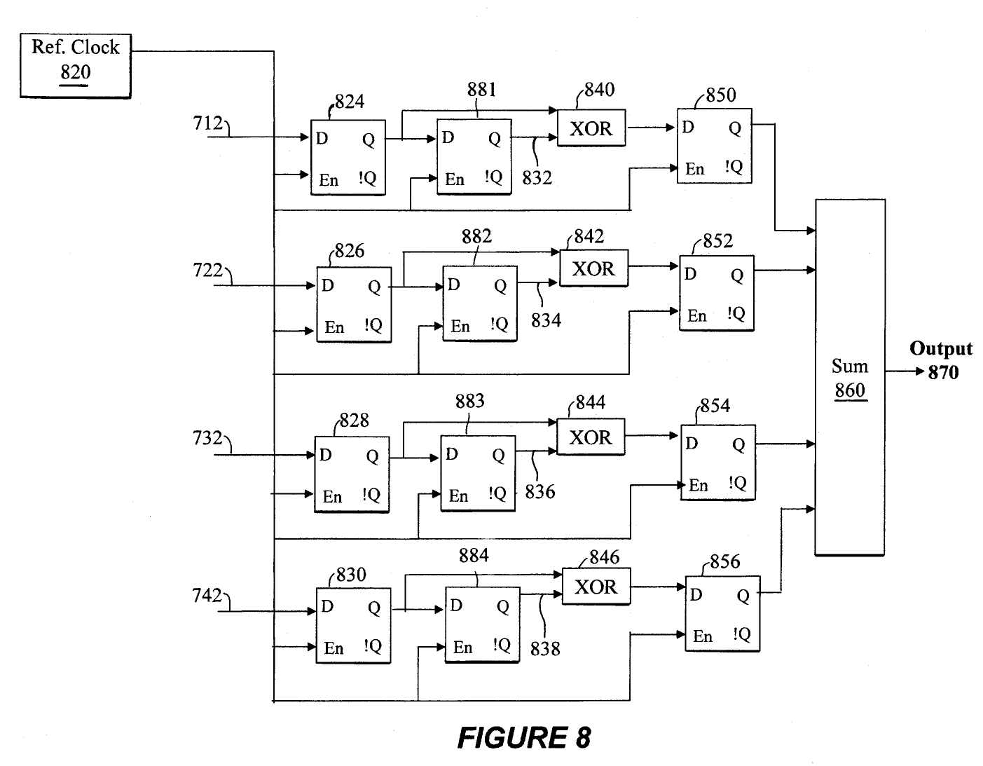

FIG. 8 illustrates a multistage circuit for extracting level change data from an input signal according to another embodiment of the disclosure. In FIG. 8, inputs 712, 722, 732 and 742 are digital data streams that are reclocked by circuit 700 of FIG. 7 to remove jitter. The parallel low speed data streams are clocked into reference clock domain 820 at logic units 824, 826, 828, 830, 881, 882, 883 and 884.

In an embodiment of the disclosure, a combination of an XOR gate and a flip-flop is used to extract level change information from data streams clocked to the reference clock domain. Other circuit elements can be used to extract level change information from each data stream without departing from the principles of the disclosure. Thus, output 832 is processed through XOR gate 840 and flip-flop 850 to extract level change information. Outputs 834, 836 and 838 are similarly processed through combination logics 842-852, 844-854, and 846-856, respectively. As will be illustrated in subsequent drawings, summer 860 receives and combines the level change information to obtain coherent output signal 870 from these data streams.

Because the level change information is preserved at each stage of the cascading circuit (see FIG. 7), the resulting sum is an accurate representation of the information provided by input signal S. In other words, the information provided by output signal 870 is substantially identical to the information provided by high frequency input signal S.

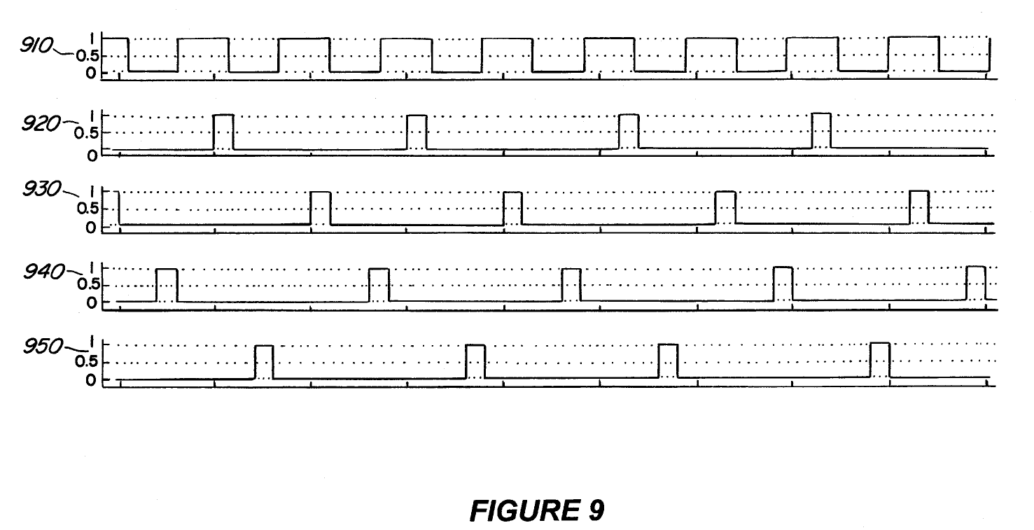

FIG. 9 shows the correlation between the first signal (332 of FIG. 3) and output signal 870 of FIG. 8. In FIG. 9, pulse train 910 shows the first signal 332 (of FIG. 3) which has a substantially identical frequency to that of the input signal S. Pulse trains 920, 930, 940 and 950 are outputs of logic units 850, 852, 854 and 856, respectively. Signals 920, 930, 940 and 950 have substantially lower frequency as compared with that of signal 910. A combination of pulse trains 920, 930, 940 and 950 yields the same information contained in signal 910. Thus, the circuit of FIG. 8 preserves all the information contained in an incoming signal and is substantially lossless.

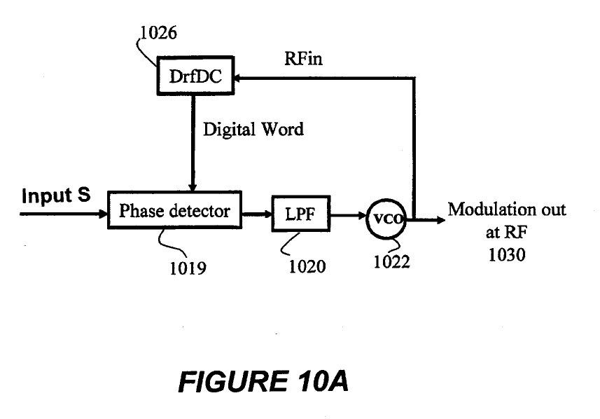

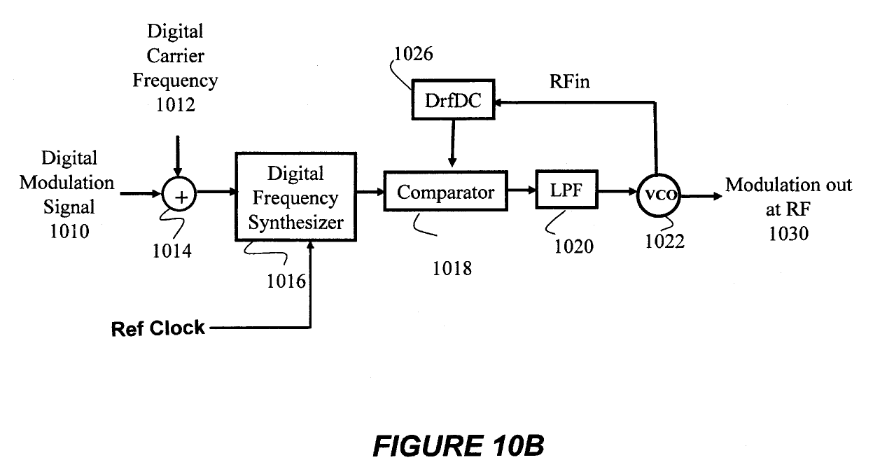

FIG. 10A is a schematic illustration of an application of a DrfDC unit in a transmitter according to one embodiment of the invention. In FIG. 10A, phase detector 1019 receives incoming RF signal and after detecting an initial phase, directs the signal to LPF 1020. The filtered signal is then directed to VCO 1022 and the output of VCO 1022 is fed to DrfDC 1026. DrfDC 1026 decomposes input RF signal as described above to form a digital word.

FIG. 10B is a schematic illustration of a frequency synthesizer using a DrfDC unit according to another embodiment of the disclosure. In FIG. 10B, digital modulation signal 1010 is combined with digital carrier frequency 1012 at modulator 1014 and the resulting signal is processed through digital frequency synthesizer 1016. Frequency synthesizer 1016 can be any conventional synthesizer circuit for generating any of a range of frequencies from an oscillator. In one embodiment of the invention, frequency synthesizer 1016 is a digiphase synthesizer.

The output of digital frequency synthesizer 1016 is a reference phase and is directed to phase comparator 1018. In one embodiment of the disclosure, comparator 1018 defines a phase frequency detector which receives and compares the incoming signal's frequency with a measured frequency. The result is directed to low-pass filter 1020 which drives VCO 1022. Output 1030 of VCO 1022 is a modulated signal at desired frequency. Directing signal 1030 to DrfDC 1026 allows measuring the frequency of the signal according to the disclosed embodiments and iteratively locking into the proper signal frequency. The DrfDC can define a multi-stage cascading circuit consistent with the principles disclosed herein.

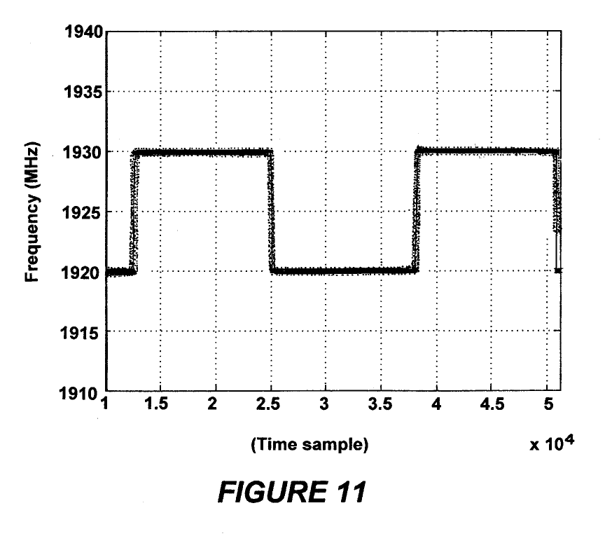

FIG. 11 shows the test results for a two-stage DrfDC apparatus prepared according to an embodiment of the disclosure. Specifically, FIG. 11 shows the test result for the frequency synthesizer of FIG. 10B in which DrfDC is defined by a two-stage cascading circuit (see FIGS. 7 and 8). In FIG. 11, the horizontal axis shows sampling time and the vertical axis shows the frequency. The incoming signal (RFᵢₙ) was about 1920/1930 MHz and the clock reference was set at 512 MHz. It can be readily seen that the output of DrfDC substantially overlaps that of the incoming signal and the two signals are synchronous. In other words, the system operates with no data loss.

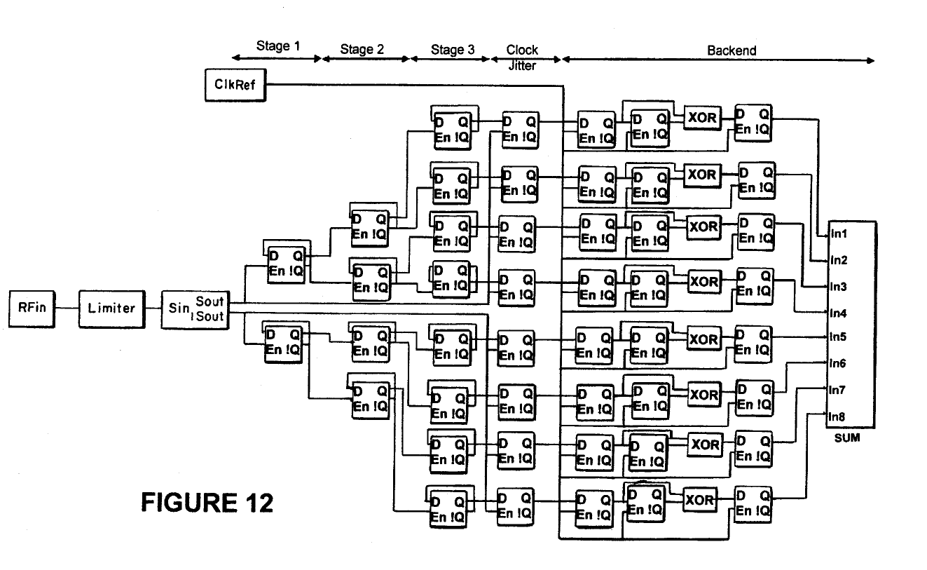

FIG. 12 is a schematic representation of a three-stage cascading DrfDC according to another embodiment of the disclosure. The DrfDC circuit of FIG. 12 is similar to that of the two-stage system shown in FIGS. 7 and 8, with the addition of eight logic units which define the stage 3. When a GSM signal was supplied as input signal to DrfDC of FIG. 12, the system was able to track the incoming signal exceptionally well.

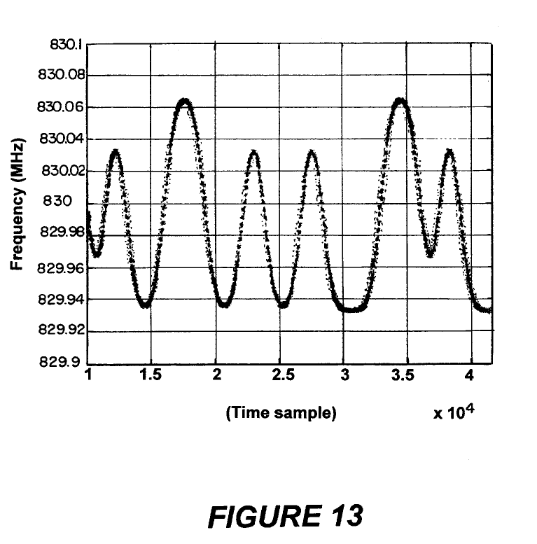

The results are presented in FIG. 13 where the incoming signal was received at GSM 850 (corresponding to carrier frequency of about 830 MHz). The reference clock was at 416 MHz and the filter frequency response was characterized as conv ([1 . . . 256 . . . 1], [1 . . . 256 . . . 1]). As evident from FIG. 13, output from the DrfDC tracks incoming signal RFᵢₙ substantially identically.

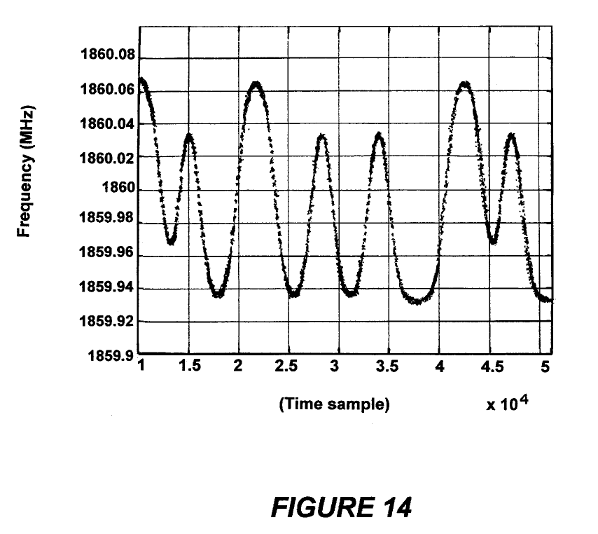

FIG. 14 shows the test results for a three-stage DrfDC apparatus operating at GSM 1900 band. Here, the input signal had a carrier frequency of about 1860 MHz and the reference clock was set at 512 MHz. As evident from FIG. 14, output from the DrfDC tracks incoming signal RFᵢₙ substantially identically. That is, the information is decomposed without loss.

The principles disclosed herein are advantageous over the conventional systems in that they provide a digital solution with substantially smaller current consumption. The circuit footprint and power consumption are also significantly smaller than the conventional systems, which require multiphase ring oscillators, local oscillators or offset PLLs. In addition, the SNR is significantly improved over comparable systems that use the divide-by-N methodology. Consequently, the present invention is particularly useful in portable or handheld transmitters using a VCO.

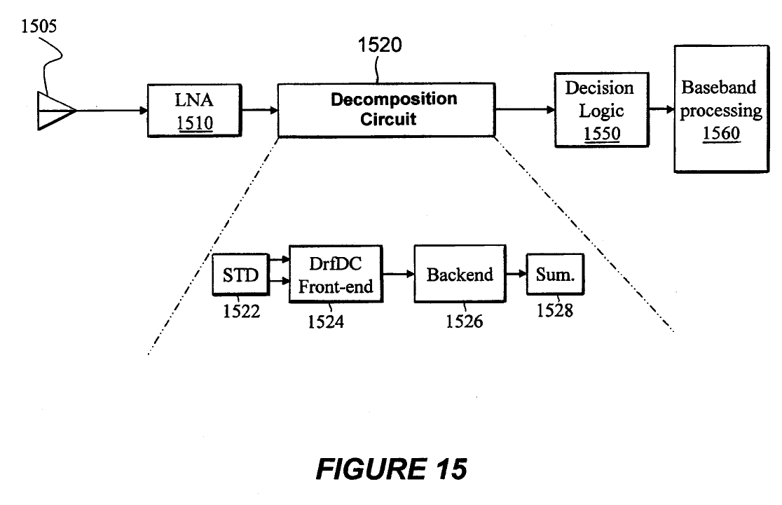

FIG. 15 is a schematic representation of a front-end receiver using an embodiment of the present invention. The embodiment of FIG. 15 can be implemented, for example, at a handheld mobile transceiver. Antenna 1505 receives an incoming signal and directs the signal to low noise amplifier (“LNA”) 1510. LNA 1510 amplifies and directs the amplified RF signal to circuit 1520.

The conventional systems typically use a down-converter (not shown) to convert high frequency signal to a baseband signal. According to the principles of this invention, decomposition circuit 1520 can be substituted for the down-converter. Decomposition circuit 1520 includes STD 1522, DrfDC 1524, backend receiver 1526 and summer 1528, the operation of which has been described in relation to FIGS. 7, 8 and 12. Decision logic 1550 receives level change information from summer 1528 and directs the information to baseband processing unit 1560. Because decomposition circuit 1520 does not require extraneous circuit components such as local oscillators, mixers or offset phase-locked loops, its footprint is significantly smaller than the known systems. As such, it is particularly suitable for low-weight, portable devices.

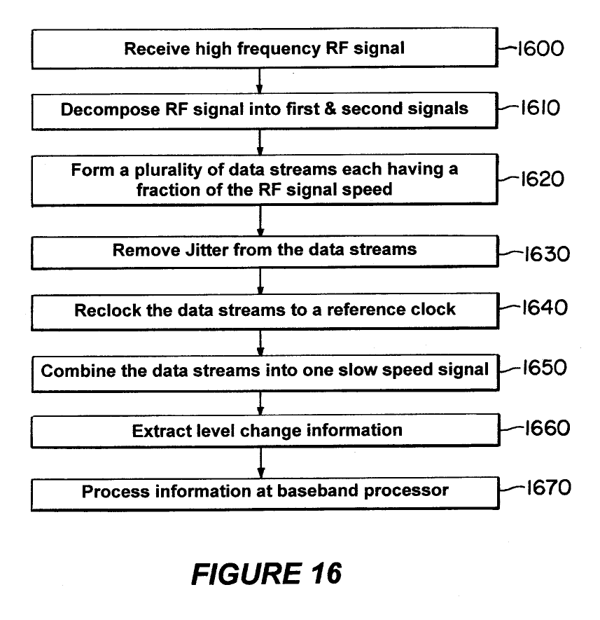

FIG. 16 is a method for implementing an embodiment of the invention in a receiver. The receiver can be one of a mobile phone, a PDA, a GPS or any other device configured to receive an incoming high frequency signal. At step 1600, the receiver receives the high frequency signal at an antenna. The received signal can optionally be processed through a limiter or a low noise amplifier (not shown). In step 1610, the incoming signal is decomposed into a first and a second signal having opposite polarities.

In step 1620, a plurality of slow-speed data streams are formed, each having a fraction of the incoming signal's speed. In one embodiment of the invention, both the rising edge and the falling edge of one of the first or the second signal are used to trigger a level change in the slow-speed data streams. In another embodiment of the invention, every other rising edge or falling edge of the first or the second signal is used to trigger a level change in the slow-speed data streams. In still another embodiment, a rising or a falling edge from among a sequence of rising or falling edges is used to trigger a level change in the slow-speed data streams.

In step 1630, jitter is removed from the slow-speed data streams. In step 1640, the slow-speed data streams are reclocked according to a reference or master clock. In step 1650, the plurality of slow-speed data streams are combined into a single data stream containing all of the level change information carried by the incoming high frequency signal. The information is then extracted from the single data stream at step 1660 and directed to the transceiver's baseband processor for further processing.

While the principles of the disclosure have been illustrated in relation to the exemplary embodiments shown herein, the principles of the disclosure are not limited thereto and include any modification, variation or permutation thereof.

What is claimed is:

1. A method for decomposing a high frequency signal to a plurality of low-frequency data streams, the method comprising:
receiving a high-frequency incoming RF signal;
decomposing the incoming signal into at least a first signal and a second signal;
processing the first signal at a first logic unit to provide a first output signal, the first output signal preserving a rising edge of the first signal;
processing the second signal at a second logic unit to provide a second output signal, the second output signal preserving a falling edge of the first signal, the second output signal being substantially synchronous with the first output signal; and
wherein each of the first output signal and the second output signal is at about half of the frequency of the incoming signal.

2. The method of claim 1, wherein the second signal is a substantial inverse of the first signal.

3. The method of claim 1, further comprising processing the first output signal to provide a third output signal, the third output signal substantially preserving rising edges of the first signal.

4. The method of claim 3, wherein the third output signal comprises a frequency of about one quarter of the frequency of the incoming signal.

5. The method of claim 3, further comprising reducing signal noise by reclocking the third output signal.

6. The method of claim 3, further comprising reclocking the third output signal to remove signal noise.

7. The method of claim 1, further comprising operating the second logic unit substantially simultaneous with the first logic unit.

8. The method of claim 1, wherein the step of preserving the rising edge of the first signal further comprises changing signal amplitude of the first signal when detecting a rising edge.

9. An apparatus for decomposing a high frequency incoming signal to a plurality of low-frequency data streams, the apparatus comprising:
a single-to-differential unit for decomposing the incoming signal into a first signal and a second signal;
a first logic unit for processing the first signal into a first output signal, the first output signal preserving a rising edge of the first signal;
a second logic unit for processing the second signal into a second output signal, the second output signal preserving a rising edge of the second signal;
the second output signal substantially synchronous with the first output signal; and
wherein each of the first output signal and the second output signal is at about half of the frequency of the incoming signal.

10. The apparatus of claim 9, wherein the single-to-differential unit forms the second signal substantially inverse of the first signal.

11. The apparatus of claim 9, wherein the first logic unit and the second logic unit form a logic device.

12. The apparatus of claim 11, further comprising a reclock circuit for receiving the first signal, the second signal and a plurality of output from the first logic device to remove signal noise.

13. The apparatus of claim 9, wherein at least one of the first logic unit or the second logic unit defines a flip-flop.

14. The apparatus of claim 9, further comprising a third logic unit for processing the first output signal to provide a third output signal, the third output signal substantially preserving the rising edge of the first differential signal, the third output signal having a frequency of about one quarter of the frequency of the incoming signal.

15. The apparatus of claim 14, wherein the third logic unit preserves every other rising edge of the first differential signal.

16. The apparatus of claim 14, further comprising a reclock circuit for receiving the first signal, the second signal and at least one output from the third logic unit to remove noise.

17. The apparatus of claim 9, wherein the first logic unit and the second logic unit operate synchronously.

18. A signal conversion system, comprising:
a decomposition circuit for decomposing a pair of high frequency differential signals to a plurality of low speed data streams;
a circuit for synchronizing the plurality of low speed data streams with the pair of high frequency differential signals to form synchronized low speed data streams;
a clock circuit for reclocking the low speed data streams; and
a logic circuit for extracting data from the reclocked low speed data streams;
the decomposition circuit having a plurality of cascading circuit elements arranged in a multitier cascade to decompose the pair of high frequency differential signals into a number of low speed data streams corresponding to a number of circuit elements in a last stage of the multitier cascade.

19. The system of claim 18, wherein at least one of the circuit elements defines a flip-flop.

20. The system of claim 18, wherein at least one of the circuit elements defines a shift-register.

21. The system of claim 18, further comprising a single-to-differential circuit for decomposing a high-frequency incoming signal into the pair of high frequency differential signals.

22. The system of claim 18, further comprising an external clock for clocking the decomposition circuit.

23. The system of claim 18, wherein the number of the circuit elements in the decomposition circuit is
$${\sum }_{i = 1}^{n} {2}^{i} ,$$
wherein n is the number of stages.

24. The system of claim 18, wherein the decomposition circuit further comprises k circuit elements in the last stage of the multitier cascade and wherein k is a positive integer.

25. The system of claim 18, further comprising a reference clock communicating a timing signal to the clock circuit.

26. The system of claim 18, wherein the clock circuit further comprises a reference clock.

27. The system of claim 18, wherein the logic circuit further comprises a plurality of logic gates extracting data from a corresponding plurality of low speed data stream.

28. The system of claim 18, further comprising a summer for combining the plurality of low speed data streams.

29. An RF transmitter system comprising:
a modulation circuit for modulating a digital signal with a digital carrier frequency to form a modulated digital signal;
a frequency synthesizer for receiving the modulated digital signal and providing an output signal;
a phase frequency detector for comparing the output signal of the frequency synthesizer with a measured frequency of a reference phase and producing an error phase signal;
a voltage-controlled oscillator for receiving the error phase signal and providing a modulation output frequency signal; and
a direct RF to digital converter (DrfDC) for receiving the modulation output frequency signal and providing a processed frequency signal to the detector;
the DrfDC having a multistage cascade of circuit elements for devising a high frequency signal to a digital word.

30. The system of claim 29, wherein the DrfDC further comprises a reclocking circuit.

31. The system of claim 29, wherein the comparator further comprises an edge detector.

32. The system of claim 29, wherein the digital word defines a phase and a frequency.

33. The system of claim 29, wherein the multistage cascade of circuit elements defines a plurality of flip-flops arranged to decompose a high frequency signal into a plurality of low-frequency signals.

34. A handheld transceiver for directly measuring frequency without down-converting an RF signal, the transceiver comprising:
an antenna for receiving the RF signal;
a low-noise amplifier for amplifying the received signal to an amplified RF signal;
a circuit for decomposing the amplified RF signal into at least one slow speed data stream containing all level change information of the RF signal;
a decision logic unit for receiving the at least one slow speed data stream and obtaining level change information therefrom; and
a baseband processor for processing the level change information;
wherein the slow speed data stream contains the level change information from all rising edges and all falling edges of the RF signal.

35. The transceiver of claim 34, wherein the circuit further comprises a single-to-differential unit for providing a pair of opposite polarity signals from the amplified RF signal.

36. The transceiver of claim 35, wherein the circuit further comprises a direct RF-to-digital converter with a multistage cascading circuit for receiving the opposite polarity signals and forming a plurality of data streams.

37. The transceiver of claim 36, wherein the circuit further comprises a summer for combining the polarity of data streams into a single data stream containing the level change information contained in the RF signal.

38. The transceiver of claim 34, wherein the handheld transceiver is selected from the group consisting of mobile telephone, personal digital assistant, geopositioning system and a radio receiver.

39. The transceiver of claim 34, wherein the circuit decomposes the amplified RF signal into a plurality of slow speed data streams, the plurality of slow speed data streams cumulatively containing all level change information of the RF signal.

40. A method for directly decomposing a high frequency RF signal to a plurality of slow-speed signals, the method comprising:
receiving the RF signal at an antenna;
amplifying the received signal to an amplified signal;
decomposing the amplified signal into at least one slow speed data stream, the slow speed data stream containing all level change information of the RF signal;
extracting the level change information from the slow speed data stream; and
processing the extracted information at a baseband processor;
wherein the slow speed digital data stream contains the level change information from all rising edges and falling edges of the RF signal.

41. The method of claim 40, further comprising obtaining a pair of signals having an opposite polarity from the amplified signal.

42. The method of claim 41, further comprising forming a plurality of cascading slow speed data streams from one of the opposing polarity signals.

43. The method of claim 42, further comprising combining the plurality of slow speed data streams into a single data stream containing all the level change information of the RF signal.

44. The method of claim 40, further comprising decomposing the amplified RF signal into a plurality of slow speed data streams, the plurality of slow speed data streams cumulatively containing all level change information of the RF signal.
